(19) United States
(12) Patent Application Publication
(10) Pub. No.: US 2011/0196698 A1
(43) Pub. Date: Aug. 11, 2011

(54) Brains-Empowered Networking

(76) Inventor: Anuthep Benja-Athon, New York, NY (US)

(21) Appl. No.: 13/065,518

(22) Filed: Mar. 24, 2011

Related U.S. Application Data
(63) Continuation-in-part of application No. 12/924,054, filed on Sep. 20, 2010.
Application No. 12/924,054 is a continuation-in-part of application No. 12/804,588, filed on Jul. 26, 2010.
Application No. 12/804,588 is a continuation-in-part of application No. 12/799,207, filed on Apr. 21, 2010.
Application No. 12/799,207 is a continuation-in-part of application No. 12/658,112, filed on Feb. 3, 2010.
Application No. 12/658,112 is a continuation-in-part of application No. 12/655,748, filed on Jan. 7, 2010.
Application No. 12/655,748 is a continuation-in-part of application No. 12/592,714, filed on Dec. 2, 2009.
Application No. 12/592,714 is a continuation-in-part of application No. 12/381,654, filed on Mar. 16, 2009.
Application No. 12/381,654 is a continuation-in-part of application No. 12/322,529, filed on Feb. 4, 2009.
Application No. 12/322,529 is a continuation-in-part of application No. 12/321,141, filed on Jan. 16, 2009.
Application No. 12/321,141 is a continuation-in-part of application No. 12/080,433, filed on Apr. 3, 2008.
Application No. 12/080,433 is a continuation-in-part of application No. 12/069,409, filed on Feb. 11, 2008.
Application No. 12/069,409 is a continuation-in-part of application No. 11/986,657, filed on Nov. 26, 2007, now abandoned.
Application No. 11/986,657 is a continuation-in-part of application No. 11/803,621, filed on May 16, 2007.
Application No. 11/803,621 is a continuation-in-part of application No. 11/716,062, filed on Mar. 9, 2007, now abandoned.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006, now abandoned.
Application No. 11/599,847 is a continuation-in-part of application No. 11/431,046, filed on May 10, 2006, now abandoned.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007, now abandoned.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 11/022,410 is a continuation-in-part of application No. 09/191,795, filed on Nov. 13, 1998, now Pat. No. 6,132,218.

(51) Int. Cl. G06Q 50/00; G06Q 10/00

(52) U.S. Cl. 705/2

(57) ABSTRACT

The computer servers and a method for speedily retrieving and displaying definitive diagnoses and related information and data on health-care, health-care services and physicians in responses to inputs of physicians and/or patients in a network or networks of computers, servers and teleconferencing platforms.

This application is a continuation-in-part of Ser. No. 12/924,054 entitled A server-guidance of health-care I filed Sep. 20, 2010, a continuation-in-part of Ser. No. 12/804,588 entitled An intelligent computer-biological electronic-neural health-care system filed Jul. 26, 2010, a continuation-in-part of Ser. No. 12/799,207 entitled Computer-created-consensus-based health-care system filed Apr. 21, 2010, a continuation-in-part of Ser. No. 12/658,112 entitled A system and method for computer-generations of diagnoses filed Feb. 3, 2010, a continuation-in-part of Ser. No. 12/655,748 entitled the Artificial-intelligent system and method for managing health-care filed Jan. 7, 2010, a continuation-in-part of Ser. No. 12/592,714 entitled the Healthcare Exchange IV filed Dec. 2, 2009, a continuation-in-part of Ser. No. 12/381,654 filed Mar. 16, 2009 entitled the Adaptable compositions of health information, a continuation-in-part of Ser. No. 12/322,529 entitled the Healthcare Exchange II filed Feb. 4, 2009, a continuation-in-part of Ser. No. 12/321,141 entitled the Best system of health and health-care data management filed Jan. 16, 2009, a continuation-in-part of Ser. No. 12/080,433 entitled The Healthcare Exchange filed Apr. 3, 2008, a continuation-in-part of Ser. No. 12/069,409 entitled the Filing of Health and Health-care data filed Feb. 11, 2008, continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007, a continuation-in-part of Ser. No. 11/637,662 entitled A vital hierarchy of data on diseases filed Dec. 13, 2006, a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/293,689 entitled A system of conserving health-care buyers' resources filed Dec. 5, 2005, a continuation-in-part of Ser. No. 11/150,878 entitled Physicians' optimal management of health information filed Jun. 13, 2005, a continuation-in-part of Ser. No. 11/074,236 entitled A system of management of health-care resources filed Mar. 7, 2005, a continuation-in-part of Ser. No. 11/022,410 entitled Physicians' way of information productions filed Dec. 27, 2004 which are pending and a continuation-in-part of U.S. Pat. No. 6,132,218 entitled Images for communication of medical information in computer granted Oct. 17, 2000 to this present patent applicant.

### FIELD OF INVENTION

A system and method for computer server-assisting the managements and controls of diseases, illnesses and disorders by, for and/or among physicians and patients.

### BACKGROUND OF THE INVENTION

The present invention is an improved prototype of the complex and most intelligent computer-biological electronic-neural system and method in medicine and health-care.

The current health-care system and the practice of medicine and surgery are and remain as archaic and inefficient as those in the past decades. One of the reasons is the lack of know-how for effecting an effective and practical technological innovation on the most efficient and speedy delivery and management of health, health-care and health-care services by and among physicians and people in the current tortuous health-care system.

The present invention expedites and improves medical-decision and health-care processes and the managements of health-care services and deliveries of patients to serve said people and humanity and, together with said pending patent applications, are the only means and solution for solving the current health and health-care woes affecting all Americans and, consequently, they produce the best health-care system the world ever known and have and the global benefits for billions of people including physicians and patients and humanity are immense.

The present invention stemming from a research provides an excellent system and method for people to directly and speedily interact among themselves and computer servers in the Internet of people and computer servers and modern communication devices to directly and speedily secure precise, accurate and vital information of great import on health, health-care and health-care services of said people. Furthermore, the outcomes and the derivatives of the present invention are numerous and immensely vital to humanity.

### SUMMARY OF THE INVENTION

Adverse events, conditions, settings and outcomes and medical and health consequences in the current health-care system are extremely common and pervasive in all nations including America due to the inefficiencies in the current system of health-care. Heretofore, there were no solutions to said dilemmas.

The present invention is an improved prototype of the complex and most intelligent computer-biological electronic-neural system and method in medicine and health-care based on the intelligence and experiences of thousands to millions of physicians and doctors in America and the rest of the world and the queries for information on health, health-care and health-care service infra of millions to billions of people all over the world enabled by the computer sciences and technologies, equipment and computer programs and software and the Internet and a network or networks of computer servers and computers and mobile communication equipment and devices on 24×7 basis from anywhere on earth and space.

The present invention provides an adaptable computer server-intelligent system and method for computer server-deducing precise and accurate individual diagnoses and related information and data on physicians' identities and practices and related treatments in a network or networks of computers, servers and teleconferencing platforms in Internet and electronic-speedily responding to individual queries for said accurate and precise information query by people using computers and mobile communication devices achievable by billions of people.

For the first time in the history of mankind, the present invention represents a prototype of the Brains-Empowered Networking or Brain-Empowered Networking whose acronym is BEN in a network or networks of computers and servers which are able to precisely and computer server-speedily retrieving, displaying and managing any and all definitive diagnoses of any and all diseases, disorders or illnesses and related information and data on health-care, health-care services and related information and data on physicians who are knowledgeable or expert in said health-care, health-care services in said computer server-speedily responses to inputs of information and data—names, addresses and telephone numbers and medical and surgical expertises and practices and specialties and Web sites—by any and all physicians and/or patients from any and all places on earth and space. The immediate and immense consequences and benefits are the most efficient managements and controls of diseases, illnesses and disorders and related developments, courses, recurrences, progressions and preventions.

### DESCRIPTION OF THE PREFERRED EMBODIMENTS

The present invention provides a system and method for computer server-assisting the managements and controls of diseases, illnesses and disorders and related developments, courses, recurrences, progressions and preventions henceforth servers by, for and/or among physicians and/or patients using computers, laptops, hand-held and mobile devices and equipment for prompting and effecting said system and method for computer server-speedily and precisely retrieving, displaying and managing any and all definitive diagnoses of any and all diseases, disorders or illnesses and related information and data on health-care, health-care services and related information and data on physicians who are knowledgeable or expert in said health-care, health-care services in said computer server-speedily responses to inputs of information and data—names, addresses and telephone numbers and medical and surgical expertises and practices and specialties and Web sites—by any and all physicians and/or patients from any and all places on earth and space.

The present invention uses and provides said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt, Flash and video enabled programs, various commercial computer programs and software and hardware infra and the innovative computer programs and software and stored procedures coupled to, communicating with and commanding said SQL Server, processor units and memories, adaptable interactive linked Web pages and electronic templates and numerous linked interactive pop-up and drop-down lists of words, terms, phrases, sentences, 2-dimensional and 3-dimensional representations of body parts, illustrations, figurines, graphics, highlights, contrasts, the macroscopic anatomy, microscopic anatomy, individual body sites, organ systems, DNA and RNA and biological and disease processes and events in said viewing screens, teleconferencing platforms comprising teleconferencing technologies and related devices and equipment, and said devices for accessing said servers by and among said individual physicians, individual groups of physicians, individual patients, individual physicians and patients comprising keyboards and viewing screens including touch-enabled viewing screens or touchscreens, enabled by Web browsers and said Web server in said network or networks.

Said innovative computer programs and software and stored procedures for creating, generating, implementing and applying:
i) said SQL databases and the SQL relations and compilations in said SQL databases;
ii) individual unique SQL units in and among said SQL tables in said SQL databases from said relations and compilations of individual unique SQL keys related to individual words, terms, phrases, sentences, 2-dimensional and 3-dimensional representations of body parts, illustrations, figurines, graphics and related word and term headers or headings;
iii) individual unique SQL units in said processor units and memories and computer automatically outputted said individual unique SQL units to said SQL tables in said SQL databases;
iv) relations individual unique SQL units in and among said SQL tables in said SQL databases comprises a process for computer server generating relations of individual unique SQL keys related to individual diagnoses in individual groups of diagnoses or syndromes in and among said SQL tables in said SQL databases;
v) individual electronic scan-and-search, signs-and-symptoms-body site plasmids henceforth individual SSPs comprises a process for computer server creating and generating individual unique signs and individual unique symptoms related to individual SQL keys related to individual keys related to individual words, terms and phrases representing macroscopic anatomy, microscopic anatomy, body sites, organ systems, biological and disease processes and events in and among SQL tables in said SQL databases;
vi) individual unique words, terms, phrases or sentences representing individual unique chief complaints, individual unique signs, individual unique symptoms and individual unique cause, palliative, provocative, quality, region, severity and temporal factors henceforth PQRST, individual unique reviews of systems, individual unique physical examinations or findings, individual unique laboratory tests and results related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes in said SQL tables in said SQL databases;
vii) individual SQL relations and compilations comprising said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases;
viii) SQL relations and compilations of said individual unique SQL keys related to clinically relevant individual SQL keys related to individual unique 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said SQL tables in said SQL databases in said viewing screens;
ix) individual adaptable interactive linked electronic templates, pop-up and drop-down clinically relevant interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens;
x) for activating and using said computer server-assisting managements and controls of diseases, illnesses and disorders and related developments, courses, recurrences, progressions and preventions.

Further to supra, the present invention provides a means and a method for activating and using said computer server-assisting managements and controls of diseases, illnesses and disorders and related developments, courses, recurrences, progressions and preventions by and among physicians and patients using computers, laptops, hand-held and mobile devices and equipment in said network or networks which is described infra.

In the earlier patent applications including, but not limited to, said Ser. No. 12/804,588 entitled An intelligent computer-biological electronic-neural health-care system filed Jul. 26, 2010, a process for creating and generating relations and compilations of words, terms, phrases, sentences, 2-dimensional and 3-dimensional representations of body parts, illustrations, figurines, graphics and related word and term headers or headings representing and related to categories comprising tens of thousands of individual diagnoses and/or syndromes, individual groups of diagnoses and/or syndromes and differential diagnoses and related chief complaints, signs and symptoms and related cause, palliative, provocative, quality, region, severity and temporal factors henceforth PQRST, reviews of systems, physical examinations or findings, laboratory results, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related qualifying information and data use by physicians of about 85 medical and surgical specialties and practices in computer .txt and html files by physicians using said devices and platforms and submitting said relations and compilations to said processor units and memories from which said individual words, terms, phrases, sentences, 2-dimensional and 3-dimensional representations of body parts, illustrations, figurines, graphics and related word and term headers or headings in said relations and compilations are computer server-automatically outputted and related by individual unique SQL keys and compiled, according to said innovative computer programs and software and stored procedures, in and among said SQL tables in said SQL databases was taught.

Further to supra, in addition, said earlier patent applications also taught said process by physicians using said a process for retrieving and displaying on said viewing screens and enabling the uses, edits, updates, improvements, expansions and inspections of said individual compilations and pools of said relations of individual diagnoses, individual syndromes and diagnoses or syndromes in individual groups of diagnoses or syndromes and related diseases, disorders, differential diagnoses and chief complaints, symptoms and signs, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and practices by and among physicians and patients using computers, laptops, hand-held and mobile devices and equipment and related computer mice, keyboards, physicians' or patients' fingers on the touch-enabled viewing screens and/or voice-activation and the like for accessing said servers henceforth devices and teleconferencing platform networked to said servers and devices henceforth platform in a network or networks of said servers, devices and platform and the Internet to access said computer server, servers, virtual server and/or virtual servers in said network or networks of computer servers and devices effected in and by said computer server or servers and effected by said Windows Server, SQL Server, Web server, Visual Studio and .Net, computer scripting languages, JavaScript, AJAX, HTML, .net, Wordpad, Notepad, .txt, Flash and video enabled programs and said innovative computer programs and software operating in said computer server or servers and Web browsers in said devices in said network or networks of computer servers and devices.

In other words, said information and data words, terms, phrases, sentences, 2-dimensional and 3-dimensional representations of body parts, illustrations, figurines such as, but not limited to, U.S. Pat. No. 6,132,218, graphics, highlights, contrasts, the macroscopic anatomy, microscopic anatomy, individual body sites, organ systems, DNA and RNA and biological and disease processes and events and related word and term headers or headings on and related to health care and health-care services—facilitated by said pending patent applications wherein numerous interactive pop-up and/or drop-down lists and/or menus of interactive said words, terms, phrases, sentences, texts, synonyms, acronyms, texts, numbers, graphics, and word and term headers or headings comprising information and data on and relating to said tens of thousands of diagnoses on diseases, disorders, health, health-care and health-care services and all related said information and data use by physicians of about 85 medical and surgical specialties and practices—are repetitively generated, submitted, stored, related, compiled or pooled in said processor units and memories and outputted to said SQL databases in and manage by said SQL server.

In said preferred embodiments of the said pending patent applications and the present invention, SQL relations and compilations of said individual words, terms, phrases, sentences, 2-dimensional and 3-dimensional representations of body parts, illustrations, figurines, graphics and related word and term headers or headings generated, used and related to said individual physicians or patients are achieved by relations and compilations of individual unique SQL keys assigned to said individual words, terms, phrases, sentences, 2-dimensional and 3-dimensional representations of body parts, illustrations, figurines, graphics and related word and term headers or headings and related individual unique SQL keys related to information and data on and related to said physicians or patients in and among said SQL tables in said SQL databases.

In first summary, therefore, said preferred embodiments of said pending patent applications and the present invention provide for the creation and generation of said SQL tables in said SQL databases comprising SQL relations and compilations of said tens of thousands of individual diagnoses and related millions of related diseases, disorders, differential diagnoses and chief complaints, symptoms and signs, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations, 2-dimensional and 3-dimensional representations of body parts, illustrations, figurines, graphics, highlights, contrasts, the macroscopic anatomy, microscopic anatomy, individual body sites, organ systems, DNA and RNA and biological and disease processes and events and related word and term headers or headings and information and data including, but not limited to, names, addresses and telephone numbers and medical and surgical expertises and practices and specialties on related physicians—henceforth also known as relational information and data—each of supra are related to individual SQL keys enabled by and according to said innovative computer programs and software and stored procedures and said SQL Server.

Uniquely, said preferred embodiments of said pending patent applications and the present invention provide for the creation and generation of individual unique SQL units, in and among said SQL tables in said SQL databases, from said SQL relations and compilations of individual unique SQL keys in said processor units and memories and computer server-automatically outputted said individual unique SQL units to said SQL tables in said SQL databases enabled by and according to said innovative computer programs and software and stored procedures and said SQL Server.

Said preferred embodiments of said pending patent applications and the present invention provide a process for computer server-automatically and repetitively scanning and checking for duplicates or repeats, doubles related to individual diagnoses and individual syndromes and related said relational information and data in and among said SQL tables in said SQL databases in said processor units and memories. Said process for computer server-automatically and repetitively scans and checks for duplicates or repeats, doubles related to diagnoses in individual groups of diagnoses or syndromes and related said relational information and data in and among said SQL tables in said SQL databases in said processor units and memories. Consequently, said computer server-automatically creating and generating individual unique SQL units comprising related unique individual SQL keys related to unique individual diagnoses and related unique individual SQL keys related to unique individual chief complaints, signs and symptoms and PQRST, reviews of systems, physical examinations or findings, laboratory tests and results, anatomical locations, anatomical sites and organ systems, macroscopic anatomy, microscopic anatomy, individual body sites, organ systems, DNA and RNA and biological and disease processes, differential diagnoses, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related information and data on individual physicians or individual groups of physicians in and among said SQL tables in said SQL databases.

In other words, there are tens of thousands of unique individual SQL units in said SQL tables in said SQL databases. Among said tens of thousands of unique individual SQL units, each and every unique SQL unit comprises one diagnosis or syndrome and clinically relevant and related diseases, disorders, differential diagnoses and chief complaints, symptoms and signs, reviews of systems and related PQRST, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations, 2-dimensional and 3-dimensional representations of body parts, illustrations, figurines, graphics, highlights, contrasts, the macroscopic anatomy, microscopic anatomy, individual body sites, organ systems, DNA and RNA and biological and disease processes and events and related word and term headers or headings and information and data including, but not limited to, names, addresses and telephone numbers and medical and surgical expertises and practices and specialties on related physicians in and among said SQL tables in said SQL databases enabled by and according to said innovative computer programs and software and stored procedures and said SQL Server.

Further to supra, in said each and every unique SQL unit, the preferred embodiments of said pending patent applications and the present invention provide for a process for computer server-automatically reassigning and relating individual unique SQL keys related to unique individual chief complaints, signs and symptoms, reviews of systems and related PQRST, physical examinations or findings, laboratory tests and results, anatomical locations, anatomical sites and organ systems, macroscopic anatomy, microscopic anatomy, individual body sites, organ systems, DNA and RNA and biological and disease processes, differential diagnoses, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related information and data on individual physicians or individual groups of physicians in said relations and compilations of SQL keys to said—and relevant to—a unique SQL key related to said unique diagnosis in said individual SQL unit in and among said SQL tables in said SQL databases. Therefore, in other words, each and every SQL unit is unique—no two SQL units in said tens of thousands of unique individual SQL units each of which representing a unique diagnosis or a unique syndrome (or individual groups of diagnoses and/or syndromes) are the same in said tens of thousands of SQL units—by virtue of supra.

Uniquely, the present invention further provides a process for generating individual unique words, terms, phrases or sentences representing individual unique chief complaints, individual unique signs, individual unique symptoms and individual unique PQRST, individual unique reviews of systems, individual unique physical examinations or findings, individual unique laboratory tests and results and DNA and RNA and biological and disease processes and events related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes in processor units and memories and in and among said SQL tables in said SQL databases. One of the preferred embodiments of the present invention provide said relations and compilations and/or SQL units for said process.

Like said creation and generation of SQL units, the present invention further provides a process for computer server-automatically and repetitively scanning and checking for duplicates or repeats, doubles related to said individual chief complaints, individual signs, individual symptoms and related individual PQRST, individual reviews of systems, individual physical examinations or findings, individual laboratory tests and results related to said individual unique keys related to said individual diagnoses or individual syndromes in all said SQL units, in and among said SQL tables in said SQL databases, in said processor units and memories. Consequently, said individual chief complaints, individual signs, individual symptoms and related individual PQRST, individual reviews of systems and related individual PQRST, individual physical examinations or findings, individual laboratory tests and results and DNA and RNA and biological and disease processes and events related to individual unique SQL keys and related to individual unique SQL keys related to individual unique anatomical locations, macroscopic anatomy, microscopic anatomy, individual body sites, organ systems, DNA and RNA and biological and disease processes and events in said processor units and memories and in said SQL tables in said SQL databases. The assigning of said relations and compilations can be achieved either by human creating said relations and compilations in the .txt and/or html documents on the viewing screens of said devices and/or by said innovative computer programs and software.

Said preferred embodiments, therefore, enabled a process for computer server creating and generating individual unique words, terms, phrases or sentences representing individual unique chief complaints and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases; a process for computer server creating and generating individual unique words, terms, phrases or sentences representing individual unique signs and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases; a process for computer server creating and generating individual unique words, terms, phrases or sentences representing individual unique symptoms and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases; a process for computer server creating and generating individual unique words, terms, phrases or sentences representing individual unique reviews of systems and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases; a process for computer server creating and generating individual unique words, terms, phrases or sentences representing individual unique physical examinations and related individual SQL keys each of which are related to clinically relevant individual unique SQL keys related to individual 2-dimensional and 3-dimensional representations of body parts, illustrations, figurines, graphics, highlights, contrasts, the macroscopic anatomy, microscopic anatomy, individual body sites, organ systems, DNA and RNA and biological and disease processes and events in said SQL tables in said SQL databases; and a process for computer server creating and generating individual unique words, terms, phrases or sentences representing individual unique laboratory testing and results and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases.

In other words, there are tens of thousands of individual unique chief complaints, individual unique symptoms, individual unique signs, individual unique reviews of systems and individual PQRST, individual unique physical examinations and individual unique laboratory tests and results and related individual unique SQL keys—related to said tens of thousands unique SQL keys relate to said tens of thousands of individual unique diagnoses in said tens of thousands of SQL units—related to individual SQL keys related to individual unique anatomical locations, macroscopic anatomy, microscopic anatomy, individual body sites, organ systems, DNA and RNA and biological and disease processes and events in and among said SQL tables.

Said preferred embodiments applied to said DNA and RNA and biological and disease processes and events.

SQL units in said SQL tables in said SQL databases. Among said tens of thousands of unique individual SQL units, each and every unique SQL unit comprises one diagnosis or syndrome and clinically relevant and related diseases, disorders, differential diagnoses and chief complaints, symptoms and signs, reviews of systems and related PQRST, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations, 2-dimensional and 3-dimensional representations of body parts, illustrations, figurines, graphics, highlights, contrasts, the macroscopic anatomy, microscopic anatomy, individual body sites, organ systems, DNA and RNA and biological and disease processes and events and related word and term headers or headings and information and data including, but not limited to, names, addresses and telephone numbers and medical and surgical expertises and practices and specialties on related physicians in and among said SQL tables in said SQL databases enabled by and according to said innovative computer programs and software and stored procedures and said SQL Server.

Uniquely, the present invention provides for the creation and generation individual SQL relations and compilations comprising said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases comprises individual relation and compilation of SQL keys related to individual unique words, terms, phrases or sentences representing individual unique chief complaints and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, chief complaint-body site plasmids or individual CCBPs—in processor units and memories and in said SQL tables in said SQL databases; individual relation and compilation of SQL keys related to individual unique words, terms, phrases or sentences representing individual unique signs and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, sign-body site plasmids or individual SNBPs—in processor units and memories and in said SQL tables in said SQL databases; individual relation and compilation of SQL keys related to individual unique words, terms, phrases or sentences representing individual unique symptoms and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, symptom-body site plasmids or individual SMBPs—in processor units and memories and in said SQL tables in said SQL databases; individual relation and compilation of SQL keys related to individual unique words, terms, phrases or sentences representing individual unique review of systems and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, symptom-body site plasmids or individual RSBPs—in processor units and memories and in said SQL tables in said SQL databases; individual relation and compilation of SQL keys related to individual unique words, terms, phrases or sentences representing individual unique physical examinations related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, physical examination-body site plasmids or individual PEBPs—in processor units and memories and in said SQL tables in said SQL databases; individual relation and compilation of SQL keys related to individual unique words, terms, phrases or sentences representing individual unique laboratory tests and results related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, laboratory test and result-body site plasmids or individual LBBPs—in processor units and memories and in said SQL tables in said SQL databases.

Further to supra, the present invention provides for the creation and generation of said SQL relations and compilations of said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases in said viewing screens of said computers, laptops, hand-held and mobile devices and equipment in said network or networks by and among physicians and patients using computers, laptops, hand-held and mobile devices and equipment the present invention provides for the generations, retrievals and displays of interactive said individual CCBPs, interactive said individual SNBPs, interactive said individual SMBPs, interactive said individual RSBPs, interactive said individual PEBPs, interactive said individual LBBPs and any combination thereof in a plurality of individual adaptable interactive linked electronic templates, pop-up and drop-down comprising said individual CCBPs, individual SNBPs, individual SMBPs, individual RSBPs, individual PEBPs and/or individual LBBPs body-site-related, body-site-associated with or clinically relevant to interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens of said computers, laptops, hand-held and mobile devices and equipment, upon pointing cursors with mice and/or fingers in said interactive words, terms, phrases, sentences, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in said viewing screens by and among physicians and patients using computers, laptops, hand-held and mobile devices and equipment.

The present invention further provides a plurality of individual adaptable interactive linked electronic templates, pop-up and drop-down comprising said individual unique SQL units in and among said SQL tables in said SQL databases from said relations and compilations of individual unique SQL keys related to individual words, terms, phrases, sentences, 2-dimensional and 3-dimensional representations of body parts, illustrations, figurines, graphics and related word and term headers or headings according to said innovative computer programs and software and stored procedures in said processor units and memories and computer server-automatically outputted to and related in and among said SQL tables in said SQL Server upon by said physicians and/or patients pointing of cursors, selecting, clicking and/or keyboarding in said viewing screens by or by and among said physicians and/or patients. Consequently, the preferred embodiments of the present invention provides for computer server-automatic generations, retrievals and displays of interactive said individual unique chief complaints and related PQRST associated with said interactive said individual CCBPs, interactive said individual unique signs and related PQRST associated with said interactive said individual SNBPs, interactive said individual unique symptoms and related interactive PQRST associated with said interactive said individual SMBPs, interactive said individual unique review of systems and related interactive PQRST associated with said interactive said individual RSBPs, interactive said individual unique physical examinations associated with said interactive said individual PEBPs, interactive said individual unique laboratory tests and results associated with said interactive individual LBBPs and any combination thereof in said plurality of individual adaptable interactive linked electronic templates, pop-up and drop-down comprising said individual CCBPs, individual SNBPs, individual SMBPs, individual RSBPs, individual PEBPs and/or individual LBBPs body-site-related, body-site-associated with or clinically relevant to interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens of said computers, laptops, hand-held and mobile devices and equipment by and among physicians and patients using computers, laptops, hand-held and mobile devices and equipment, upon pointing cursors with mice and/or fingers in said interactive words, terms, phrases, sentences, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in said viewing screens by and among physicians and patients using computers, laptops, hand-held and mobile devices and equipment, enabled by JavaScript, AJAX and HTML, Flash programs and said innovative computer programs and software, stored procedures, Web browsers and Web server.

In passing, it is to be understood that said plasmid and plasmids are metaphor used supra to facilitate understanding of said preferred embodiments, means and method—and their derivatives and adaptations—of the present invention. In reality, as described supra, said metaphor representing SQL relations and compilations of SQL keys related to said individual unique words, terms, phrases or sentences representing individual unique chief complaints and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes in processor units and memories and in and among said SQL tables in said SQL databases.

Uniquely, the method and means of the present invention provide a process for activating and using said computer server-assisting managements and controls of diseases, illnesses and disorders and related developments, courses, recurrences, progressions and preventions by and among physicians and patients using computers, laptops, hand-held and mobile devices and equipment in said network or networks. In other words, said preferred embodiments can effect computer server-speedily and precisely retrieving, displaying and managing any and all definitive diagnoses of any and all diseases, disorders or illnesses and related information and data on health-care, health-care services and related information and data on physicians who are knowledgeable or expert in said health-care, health-care services in said computer server-speedily responses to inputs of information and data—names, addresses and telephone numbers and medical and surgical expertises and practices and specialties and Web sites—by any and all physicians and/or patients from any and all places on earth and space. The immediate and immense consequences and benefits are the most efficient managements and controls of diseases, illnesses and disorders and related developments, courses, recurrences, progressions and preventions.

In other words, said servers in said preferred embodiments of the present invention are able to computer server-speedily respond to individual human queries on diagnoses of diseases, disorders and illnesses and related and to precisely retrieve, display said individual precise diagnoses and enable the managements and controls of diseases, illnesses and disorders and related developments, courses, recurrences, progressions and preventions by and/or for any and all physicians and/or patients from any and all places on earth and space.

Supra is computer server-speedily performed and achieved in said servers on 24/7 for any and all physicians and/or patients from any and all places on earth and space by using and applying said plamids and SQL units in said processor units and memories.

One of the preferred embodiments of the present invention is a computer server-automatically retrieving, associating and displaying said interactive individual plasmids—in and among said SQL tables—related to individual interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens of said computers, laptops, hand-held and mobile devices and equipment upon prompting by physicians and/or patients pointing cursors with mice and/or fingers on said items in said viewing screens.

Further to supra, by pointing cursors with mice and/or fingers and selecting and clicking said interactive said individual unique chief complaints and related PQRST associated with said interactive said individual CCBPs, interactive said individual unique signs and related PQRST associated with said interactive said individual SNBPs, interactive said individual unique symptoms and related interactive PQRST associated with said interactive said individual SMBPs, interactive said individual unique review of systems and related interactive PQRST associated with said interactive said individual RSBPs, interactive said individual unique physical examinations associated with said interactive said individual PEBPs, interactive said individual unique laboratory tests and results associated with said interactive individual LBBPs and any combination thereof in said plurality of individual adaptable interactive linked electronic templates, pop-up and drop-down comprising said individual CCBPs, individual SNBPs, individual SMBPs, individual RSBPs, individual PEBPs and/or individual LBBPs body-site-related, body-site-associated with or clinically relevant to interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens of said computers, laptops, hand-held and mobile devices and equipment by and among physicians and patients using computers, laptops, hand-held and mobile devices and equipment by and among physicians and patients.

In other words, an example of numerous examples of said preferred embodiments, by pointing cursors with mice and/or fingers on a anatomical site said interactive said individual unique chief complaints and related PQRST associated with said interactive said individual CCBPs, for example, will appear and by pointing cursors with mice and/or fingers and selecting and clicking said interactive said individual unique chief complaints and related PQRST in said individual CCBPs, any and all clinically relevant plasmids will appear on clinically relevant individual interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens of said computers, devices and equipment being used by said physicians and/or patients.

By sequentially, by said pointing cursors with mice and/or fingers and selecting and clicking said displays comprise individual unique chief complaints and related PQRST, said individual unique signs and related PQRST, said individual unique symptoms and related interactive PQRST, said individual unique review of systems and related interactive PQRST, said individual unique physical examinations and/or said individual unique laboratory tests and results in said plurality of linked pop-up and drop-down—adjustably and relevantly associated to any and all displayed interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens—and any combination thereof, said selected and clicked are computer server-automatically submitted to said processor units and memories wherein said servers automatically and sequentially scan and match said selected and clicked individual unique chief complaints and related PQRST, selected said individual unique signs and related PQRST, selected said individual unique symptoms and related interactive PQRST, selected said individual unique review of systems and related interactive PQRST selected said individual unique physical examinations and/or said individual unique laboratory tests and results with same said individual words, terms, phrases and sentences representing individual chief complaints, signs and symptoms, reviews of systems and related PQRST, physical examinations or findings, laboratory tests and results related to said individual unique SQL keys related to individual unique SQL keys related to individual diagnoses or individual syndromes in said SQL units, in and among said SQL tables in said SQL databases, in said processor units and memories.

The present invention also provides for a process for computer server-sequentially and dynamically adapting and adjusting said displayed compositions of said contents in said clinically relevant plasmids in said viewing screens in adaptable responses to said adaptable and changing pointing of cursors with mice and/or fingers and selections and clicks and different orders and sequences of said applications of pointing of cursors with mice and/or fingers and selections and clicks by and/or among said physicians and/or patients.

Similarly, the present invention also provides for a process for computer server-automatically and continually adjusting, editing, setting and resetting said displays of said interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events and individual plasmids consequent to said process for varying said pointing of cursors, selecting and clicking in said viewing screens by or by and among said physicians and/or patients.

Consequently, adaptable and variable displayed outcomes in said viewing screens of said preferred embodiments including server-sequential and dynamic selections and displays of said plurality of diagnoses and/or, precisely, selections and displays individual diagnoses and related information and data on biological and disease processes and events and related information and data on individual physicians or individual groups of physicians in said viewing screens for and/or among said physicians and/or patients, enabled by said individual unique SQL keys in said individual unique SQL units in and among said SQL tables in said SQL databases according to said innovative computer programs and software and stored procedures, enabled by and according to said innovative computer programs and software and stored procedures.

In other words, said preferred embodiments enable said selected and clicked to scan, match said selected and clicked with same individual chief complaints, signs and symptoms, reviews of systems and related PQRST, physical examinations or findings, laboratory tests and results related to said individual unique SQL keys which are related to individual unique SQL keys related to individual diagnoses or individual syndromes in said SQL units, in and among said SQL tables in said SQL databases, in said processor units and memories. It is said same individual chief complaints, signs and symptoms, reviews of systems and related PQRST, physical examinations or findings, laboratory tests and results or any combination thereof in one SQL unit in said tens of thousands of SQL units that will precisely match said selected and clicked, for example, in said processor units and memories for enabling and effecting said servers to retrieve and display said definitive diagnosis and related said information and data such as, but not limited to, on and related to physicians and supra related by said SQL keys in and among said tables.

Although the large capacity processor units and memories is required to serve said physicians and patients 24/7 from all over the world, one said preferred embodiment can reduce the congestion and speed up said processing by said servers or networks of servers in said network or networks. Several preferred embodiments of the present invention can and will be implemented to speedily and accurately achieve the goals and objectives of the present invention. For example, by said inherent virtues of said SQL units and plasmids, said each scanning and matching of hundreds of thousands to millions of words, terms, phrases and sentences in said SQL units with said selected and clicked can quickly and early set aside any SQL units whose at least one word, term, phrase or sentence element—early on in said scanning and matching—may not match said selected and clicked in said processor units and memories.

Said preferred embodiments effect said selected and clicked individual unique chief complaints and related PQRST, said individual unique signs and related PQRST, said individual unique symptoms and related interactive PQRST, said individual unique review of systems and related interactive PQRST, said individual unique physical examinations and/or said individual unique laboratory tests and results and/or any combination thereof.

It is to be understood that the present invention provides also keyboarding and voice-enabled means for interacting in said preferred embodiments.

Although said preferred embodiments of the present invention provide a means and method for computer server-automatically, sequentially and dynamically adapting, adjusting, responding and displaying said plurality of diagnoses and/or, precisely, selecting and displaying individual diagnoses and related information and data on biological and disease processes and events and related information and data on individual physicians or individual groups of physicians in said viewing screens for or for and among said physicians and/or patients, enabled by said individual unique SQL keys in said individual unique SQL units in and among said SQL tables in said SQL databases according to said innovative computer programs and software and stored procedures, enabled by and according to said innovative computer programs and software and stored procedures, it will be appreciated by those skilled in the art and medicine that more complex and extensive algorithms and adaptations, variations, and derivatives are and will be made and achieved without departing from the spirit and the scope of the claims of the present invention.

Although various preferred embodiments and representations of the present invention have been described wherein a process for computer server creating and generating individual unique words, terms, phrases or sentences representing individual unique chief complaints, individual unique signs, individual unique symptoms and individual unique PQRST, individual unique reviews of systems, individual unique physical examinations or findings, individual unique laboratory results, individual unique anatomical locations, individual unique anatomical sites, individual unique organ systems, it is to be understood that information and data can be used to computer server generating said preferred embodiments applicable to computer server creating and generating individual unique words, terms, phrases or sentences representing individual unique genetics, individual unique etiologies, individual unique causes, individual unique sources and individual unique pathologic basis of diseases and illnesses, individual unique family histories, individual unique travel histories, individual unique treatments, individual unique surgeries, individual unique procedures, individual unique assessments and plans, medications, individual unique recommendations, individual unique advices, individual unique referrals and individual unique follow-ups and related adjectives and variables and synonyms, acronyms and graphics in said SQL tables in said SQL databases within the spirit and scope of the claims of the present invention.

It is to be understood that creating and generating individual words, terms, phrases and sentences and related word and term headers or headings representing and related to categories of chief complaints, signs and symptoms and PQRST, reviews of systems, physical examinations or findings, laboratory results, anatomical locations, anatomical sites and organ systems, diagnoses, syndromes, related diagnoses and/or syndromes, differential diagnoses, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related qualifying information and data use by physicians of about 85 medical and surgical specialties and practices by individual physicians or individual groups of physicians may also be performed and achieved by people and any individuals—in lieu of physicians—who has knowledge and skill on said subjects, matters and information and data using any devices, means and methods.

It is to be understood that the present invention also provides said system and method and said algorithms as represented by said one algorithms—applicable to the remaining categories and combinations of said categories of family histories, genetics, immunizations, treatments, surgeries, procedures, medications, drugs and therapeutics and effects and side-effects on human organs and bodies of said medications, drugs and therapeutics, assessments and plans, guidelines, protocols, referrals, recommendations by the relational SQL unites and SQL keys for eliminating the random, tedious and time-consuming and costly processes for searching for and referring to physicians and coordinating health and health-care services among said physicians and people and optimizing health, preventive health-care, continuity of health-care, managing chronic diseases and health-care of people.

It is factually reasonable and accurate to claim that said preferred embodiments of the present invention epitomize and represent a truly first globally vast, complex and most intelligent computer-biological electronic-neural system and method comprising computer servers, virtual servers and devices in a network or networks of computer servers, virtual servers, devices and thousands to hundreds of thousands of physicians and billions of people using said network or networks of computer servers and virtual servers and devices possessing and operating improvable innovative computer programs, software and adaptable, improvable, expandable, immensely compiled, related and pooled relational information and data on medicine, health, health-care and health-care services for managing the optimal or the best qualities, quantities and deliveries of health, health-care and health-care services by physicians for billions of people. Further fact, said preferred embodiments, in many settings and circumstances, exceed the performances and outputs of the memory, reasoning, deductive, analytical and logical capabilities of physicians' brains.

The present invention provides operating and functioning said computer servers possessing and operating memories, processors, at least a server operating system, a Windows Server, a SQL Server and computer scripting languages coupled to the innovative computer programs and software infra, a Visual Studio and .Net, Java script, AJAX, HTML, XHTML, Flash and video, a Microsoft ITS, Apache, a Web browser, Web server and possessing and operating the present applicant's invented innovative computer programs and software for commanding and communicating for commanding and communicating with said SQL Server and said relational database and/or databases and coupling with said computer scripting languages and said innovative computer programs and software for creating and generating a plurality of individual interactive and adaptable related electronic templates, a plurality of interactive pop-up and/or drop-down lists and/or menus of words, terms, phrases, sentences, texts, synonyms, acronyms, texts, numbers, graphics, and word and term headers or headings comprising information and data on and relating to said diagnoses on diseases, disorders, health, health-care and health-care services in categories of chief complaints, signs and symptoms, reviews of systems, physical examinations or findings, laboratory results, anatomical locations, anatomical sites and organ systems, diagnoses, differential diagnoses, treatments, assessments and plans, recommendations, advices, referrals and follow-ups henceforth information and data use by physicians of about 85 medical and surgical specialties and practices, for creating, generating, expanding and improving SQL databases and tables comprising relational SQL keys related to said words and terms representing said in said SQL databases and tables in said SQL Server, for creating, compiling, pooling and relating relational information and data in said SQL databases and tables and relational SQL units, for repetitively scanning and checking for redundant duplicates or repeats, doubles in individual physicians' submissions related to individual diagnoses or individual syndromes or diagnoses in individual groups of diagnoses and related relational information and data in said SQL databases and tables, for removing said redundant duplicates or repeats, doubles from relational information and data from said SQL databases, tables and said relational SQL units and for not inserting said redundant duplicates or repeats, doubles into said relational information and data in said SQL databases and tables and relational SQL units, for creating, generating and maintaining said relational SQL units comprising relational SQL keys in said SQL databases and tables comprising plurality of said information and data tables, for creating, generating and maintaining individual unique relational SQL units comprising said relational SQL keys, for creating, generating and maintaining said unique relational SQL units comprising said relational SQL keys without redundant repeats and duplicates of SQL keys in said relational SQL units, for generating queries for said information on individual information on individual physicians' identities and practices and individual diagnoses and related treatments and differential diagnoses by people, for enabling said computer server or servers to process the relations of said words and terms and said relational SQL units and words and terms in said queries in said SQL Server and in said memories of said computer server or servers, for providing and instructing computer server or servers to execute algorithms for processing said relations of said words and terms and said relational SQL units and words and terms in said queries in said SQL Server and in said memories of said computer server or servers, for providing and instructing computer server or servers to sequentially scan and match said words and terms and said relational SQL units and words and terms in said queries, for providing and instructing computer server or servers to sequentially select said information on individual physicians' identities and practices and specialties individual diagnoses and related treatments and differential diagnoses on viewing screens and for providing and enabling said computer server or server to display said information on individual physicians' identities and practices and specialties individual diagnoses and related treatments and differential diagnoses on viewing screens.

The present invention provides said innovative computer programs and software invented by the present patent applicant which were filed with and are stored in the Library of Congress in Washington, D.C. The present invention uses also the commercially available computer software (plural), programs and computer languages such as, but not limited to, those made and sold by Adobe Systems, Inc. such as, but not limited to, Flash and Flash video and streaming technologies and Microsoft Corporation such as, but not limited to, Microsoft Windows Server operating system, Chrome operating system, Linux, SQL servers such as, but not limited to Microsoft SQL Server, MySQL and the like, Internet Explorer, various other Web browsers such as, but not limited to Firefox browser by Mozilla Foundation, Chrome Web browser, Safari, Opera and derivatives, Web server, Apache, Microsoft IIS, Visual Studio and .Net, Microsoft software including Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML and the like and related and their derivatives. Other computer programs and software also include application software (plural) also known as Applications or Apps for manipulating, texting, numbering, graphics, or any combinations of these elements for uses and applications with iPhone and iPad of Apple, Inc. and Google's Android software. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate. It is obvious and known that with more extensive operations, requirements and equipment, server blades and various hardware and equipment configurations, virtual servers such as those sold by VMware, HP and IBM, and their derivatives being used by many large American corporations can and will be used to implement the present invention. Said programs and software enabled individuals and individual groups of people to use and apply the present invention.

Said preferred embodiments of the present invention are applicable to and used by individual physicians, individual patients, individual groups of physicians and individual groups of physicians and individual patients in same and diverse and different settings and locations. In other words, the preferred embodiments of the present invention are also enabled by popular commercial technologies provided www.webex.com by Cisco Systems, Inc. and www2.gotomeeting.com by Citrix Online, L.L.C. and the like provided by other companies or corporations for enabling individual persons in various and different settings and locations to conference or use said embodiments as individual groups of people being in said diverse or different settings and locations using said network or networks and the Internet to achieve the goals and objectives of the present invention. Said programs and software and the derivatives and the like enabled individuals and individual groups of people to use and apply the present invention.

Although sequences of applications of individual interactive words and terms representing diagnoses, syndromes and diagnoses or syndromes in individual groups of diagnoses or syndromes and compiled, related or pooled relational information and data on and related to diagnoses, syndromes and diagnoses or syndromes in individual groups of diagnoses or syndromes and related chief complaints, symptoms and signs, differential diagnoses, reviews of systems, physical examinations, family histories, genetics, immunizations, laboratories, imaging, body fluid tests and tissues examinations, assessments and plans, medications, treatments, procedures, surgeries, recommendations, guidelines, referrals, follow-ups, organs and anatomical sites and parts of humans and physicians' practices related to said diagnoses or said individual groups of diagnoses as one of the preferred embodiments of the present invention have been described, it is to be appreciated and understood by those skilled in the art that various combinations, permutations and orders of sequences of applications of said words, terms and phrases are some of the preferred embodiments of the present invention and are made, used and achieved without departing from the spirit and the scope of the claims of the present invention.

It is to be understood that said servers of the present invention also further embodied any and all computers and mobile computers such as, but not limited to, and server blades and various hardware and equipment configurations, virtual servers such as those sold by VMware, HP and IBM, and their derivatives being used by many large American corporations can and will be used to implement the present invention. Furthermore, it is to be understood that computer or computers in the claims infra may also implied computer server, computer servers, virtual server, virtual servers.

It is to be understood that the system and method taught by U.S. Pat. No. 6,132,218 entitled Images for communication of medical information in computer granted Oct. 17, 2000 to this present patent applicant will be incorporated into said preferred embodiments of the present invention to achieve the goals and objectives of the present invention.

Although the preferred embodiments of this invention have been described for humans, it will be appreciated by those skilled in the art that adaptations and variations of the present invention may be made to apply to other species, animals, biological entities or structures, infectious particles or structures, and machines without departing from the spirit of the invention and the scope of the claims.

Although various preferred embodiments and representations of the present invention have been described, it will be appreciated by those skilled in the art that the real and practical implementations and their adaptations, variations and derivatives are and will be made and achieved without departing from the spirit and the scope of the claims of the present invention.

1. A computer server or servers for assisting the managements and controls of diseases, illnesses and disorders and related developments, courses, recurrences, progressions and preventions henceforth servers by, for and/or among physicians and/or patients using computers, laptops, hand-held and mobile devices and equipment for accessing said servers henceforth devices and teleconferencing platform networked to said servers and devices henceforth platform in a network or networks of said servers, devices and platform comprises:
said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt, Flash and video enabled programs, and said innovative computer programs and software and stored procedures coupled to, communicating with and commanding said SQL Server, processor units and memories, adaptable interactive linked Web pages and electronic templates and numerous linked interactive pop-up and drop-down lists of words, terms, phrases, sentences, 2-dimensional and 3-dimensional representations of body parts, illustrations, figurines, graphics, highlights, contrasts, the macroscopic anatomy, microscopic anatomy, individual body sites, organ systems, DNA and RNA and biological and disease processes and events in said viewing screens, teleconferencing platforms comprising teleconferencing technologies and related devices and equipment, and said devices for accessing said servers by and among said individual physicians, individual groups of physicians, individual patients, individual physicians and patients comprising keyboards and viewing screens including touch-enabled viewing screens or touchscreens, enabled by Web browsers and said Web server in said network or networks;
SQL tables in said SQL databases in and managed by said SQL Server comprising SQL relations and compilations of individual diagnoses, individual syndromes, individual groups of diagnoses and syndromes and related differential diagnoses and related chief complaints, signs and symptoms and PQRST, reviews of systems, physical examinations or findings, laboratory results, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related qualifying information and data use by physicians of about 85 medical and surgical specialties and practices and related words, terms, phrases, sentences, 2-dimensional and 3-dimensional representations of body parts, illustrations, figurines, graphics, highlights, contrasts, the macroscopic anatomy, microscopic anatomy, individual body sites, organ systems, DNA and RNA and biological and disease processes and events related to individual SQL keys created and enabled and effected by and according to said innovative computer programs and software and stored procedures;
individual unique SQL units in and among said SQL tables in said SQL databases;
individual unique words, terms, phrases or sentences representing individual unique chief complaints, individual unique signs, individual unique symptoms and individual unique PQRST, individual unique reviews of systems, individual unique physical examinations or findings, individual unique laboratory tests and results related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes;
individual SQL relations and compilations comprising said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases;
said innovative computer programs and software and stored procedures for creating, generating, implementing and applying:
i) said SQL databases and the SQL relations and compilations in said SQL databases;
ii) individual unique SQL units in and among said SQL tables in said SQL databases from said relations and compilations of individual unique SQL keys related to individual words, terms, phrases, sentences, 2-dimensional and 3-dimensional representations of body parts, illustrations, figurines, graphics and related word and term headers or headings;
iii) individual unique SQL units in said processor units and memories and computer automatically outputted said individual unique SQL units to said SQL tables in said SQL databases;
iv) relations individual unique SQL units in and among said SQL tables in said SQL databases comprises a process for computer server generating relations of individual unique SQL keys related to individual diagnoses in individual groups of diagnoses or syndromes in and among said SQL tables in said SQL databases;
v) individual electronic scan-and-search, signs-and-symptoms-body site plasmids henceforth individual SSPs comprises a process for computer server creating and generating individual unique signs and individual unique symptoms related to individual SQL keys related to individual keys related to individual words, terms and phrases representing macroscopic anatomy, microscopic anatomy, body sites, organ systems, biological and disease processes and events in and among SQL tables in said SQL databases;
vi) individual unique words, terms, phrases or sentences representing individual unique chief complaints, individual unique signs, individual unique symptoms and individual unique PQRST, individual unique reviews of systems, individual unique physical examinations or findings, individual unique laboratory tests and results related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes in said SQL tables in said SQL databases;
vii) individual SQL relations and compilations comprising said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases;
viii) SQL relations and compilations of said individual unique SQL keys related to clinically relevant individual SQL keys related to individual unique 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said SQL tables in said SQL databases in said viewing screens;
ix) individual adaptable interactive linked electronic templates, pop-up and drop-down clinically relevant interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens;
x) for activating and using said computer server-assisting managements and controls of diseases, illnesses and disorders and related developments, courses, recurrences, progressions and preventions; and
a means for activating and using said computer server-assisting managements and controls of diseases, illnesses and disorders and related developments, courses, recurrences, progressions and preventions by and among physicians and patients using computers, laptops, hand-held and mobile devices and equipment in said network or networks.

2. The servers according to claim 1 wherein said individual unique SQL units each of which comprises SQL relations and compilations of individual unique SQL keys related to individual unique diagnosis or individual unique syndromes and related SQL keys related to differential diagnoses and related chief complaints, signs and symptoms and PQRST, reviews of systems, physical examinations or findings, laboratory tests and results, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related qualifying information and data and related SQL keys related to information and data on individual physicians or individual groups of physicians in and among said SQL tables in said SQL databases.

3. The servers according to claim 1 wherein said means for activating and using said computer server-assisting managements and controls of diseases, illnesses and disorders and related developments, courses, recurrences, progressions and preventions by and among physicians and patients using computers, laptops, hand-held and mobile devices and equipment in said network or networks comprises:
said individual unique words, terms, phrases or sentences representing individual unique chief complaints, individual unique signs, individual unique symptoms and individual unique PQRST, individual unique reviews of systems, individual unique physical examinations or findings, individual unique laboratory tests and results related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes;
individual CCBPs, individual SNBPs, individual SMBPs, individual RSBPs, individual PEBPs and/or individual LBBPs body-site-related, body-site-associated with or clinically relevant to interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens of said computers, laptops, hand-held and mobile devices and equipment, upon pointing cursors with mice and/or fingers in said interactive words, terms, phrases, sentences, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in said viewing screens; and
said individual unique SQL units in and among said SQL tables in said SQL databases; and
individual unique words, terms, phrases or sentences representing individual unique chief complaints, individual unique signs, individual unique symptoms and individual unique PQRST, individual unique reviews of systems, individual unique physical examinations or findings, individual unique laboratory results related to individual unique SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes in and among said SQL tables in said SQL databases;
individual information and data on individual physicians and individual groups of physicians related to individual unique SQL keys related to individual unique keys related to individual diagnoses and individual syndromes in and among said SQL tables in said SQL databases.

4. In a computer server or servers for assisting the managements and controls of diseases, illnesses and disorders and related developments, courses, recurrences, progressions and preventions henceforth servers by and among physicians and patients using computers, laptops, hand-held and mobile devices and equipment for accessing said servers henceforth devices and teleconferencing platform networked to said servers and devices henceforth platform in a network or networks of said servers, devices and platform, a method for computer server-assisting the managements and controls of diseases, illnesses and disorders and related developments, courses, recurrences, progressions and preventions by, for and/or among physicians and/or patients using computers, laptops, hand-held and mobile devices and equipment for accessing said servers henceforth devices and teleconferencing platform networked to said servers and devices henceforth platform in a network or networks of said servers, devices and platform comprises:
a process for operating said operating and functioning computer servers including said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt, Flash and video enabled programs, and said innovative computer programs and software coupled to, communicating with and commanding said SQL Server, processor units and memories, adaptable interactive linked Web pages and electronic templates and numerous linked interactive pop-up and drop-down lists of words, terms, phrases, sentences, 2-dimensional and 3-dimensional representations of body parts, illustrations, figurines, graphics, highlights, contrasts, the macroscopic anatomy, microscopic anatomy, individual body sites, organ systems, DNA and RNA and biological and disease processes and events in said viewing screens, teleconferencing platforms comprising teleconferencing technologies and related devices and equipment, and said devices for accessing said servers by and among said individual physicians, individual groups of physicians, individual patients, individual physicians and patients comprising keyboards and viewing screens including touch-enabled viewing screens or touchscreens, enabled by Web browsers and said Web server in said network or networks;
a process for creating, implementing and applying SQL relations and compilations in said SQL tables in said SQL databases;
a process for creating, implementing and applying said innovative computer programs and software and stored procedures coupled to said processor units, memories and SQL Server in said servers;
a process for creating and generating relations and compilations of words, terms, phrases, sentences, 2-dimensional and 3-dimensional representations of body parts, illustrations, figurines, graphics and related word and term headers or headings representing and related to categories of diagnoses and/or syndromes, differential diagnoses and related chief complaints, signs and symptoms and PQRST, reviews of systems, physical examinations or findings, laboratory results, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related qualifying information and data use by physicians of about 85 medical and surgical specialties and practices in computer files by physicians using said devices and platforms and submitting said relations and compilations to said processor units and memories from which said relations and compilations are computer server-automatically outputted and related by individual unique SQL keys and compiled, according to said innovative computer programs and software and stored procedures, in and among said SQL tables in said SQL databases;
a process for computer server creating and generating individual unique SQL units in and among said SQL tables in said SQL databases from said relations and compilations of individual unique SQL keys related to individual words, terms, phrases, sentences, 2-dimensional and 3-dimensional representations of body parts, illustrations, figurines, graphics and related word and term headers or headings according to said innovative computer programs and software and stored procedures in said processor units and memories and computer server-automatically outputted to and related in and among said SQL tables in said SQL Server;
a process for computer server-automatically creating and generating relations individual unique SQL units in and among said SQL tables in said SQL databases;
a process for computer server creating and generating individual unique words, terms, phrases or sentences representing individual unique chief complaints, individual unique signs, individual unique symptoms and individual unique PQRST, individual unique reviews of systems, individual unique physical examinations or findings, individual unique laboratory results related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes in said SQL tables in said SQL databases;
a process for computer server creating and generating SQL relations and compilations of said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases;
a process for generating said SQL relations and compilations of said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases in said viewing screens of said computers, laptops, hand-held and mobile devices and equipment in said network or networks by and among physicians and patients using computers, laptops, hand-held and mobile devices and equipment;
a process for activating and using said computer server-assisting managements and controls of diseases, illnesses and disorders and related developments, courses, recurrences, progressions and preventions by and among physicians and patients using computers, laptops, hand-held and mobile devices and equipment in said network or networks; and
a process for creating, generating, implementing and applying said SQL databases and the SQL relations and compilations in said SQL tables in said SQL databases in said servers in said network or networks by and according to said innovative computer programs and software and stored procedures in said processor units and memories and computer server-automatically outputted said relations and compilations to and related in and among said SQL tables in said SQL Server, enabled by and according to said innovative computer programs and software and stored procedures in said processor units and memories and computer server-automatically outputted to and related in and among said SQL tables in said SQL Server.

5. The method according to claim 4 wherein said process for creating, generating, implementing and applying said SQL databases and the SQL relations and compilations in said SQL databases in said servers in said network or networks by said innovative computer programs and software and stored procedures in said processor units and memories and outputting to and related in and among said SQL tables in said SQL Server comprises:
a process for creating and generating individual words, terms, phrases and sentences and related word and term headers or headings representing and related to categories of chief complaints, signs and symptoms and PQRST, reviews of systems, physical examinations or findings, laboratory tests and results, anatomical locations, anatomical sites and organ systems, diagnoses, syndromes, related diagnoses and/or syndromes, differential diagnoses, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related qualifying information and data use by physicians of about 85 medical and surgical specialties and practices by physicians;
a process for creating and generating individual words, terms, phrases and/or sentences representing the macroscopic anatomy, microscopic anatomy, individual body sites, organ systems, DNA and RNA and biological and disease processes and eventsrelated to individual SQL keys in SQL tables in said SQL databases;
a process for computer server-creating and generating individual unique SQL units from computer server-processing said relations and compilations of individual unique SQL keys representing words, terms, phrases and sentences and related word and term headers or headings generated and inputted into said processor units and memories and SQL databases by said physicians in said processor units and memories and SQL tables in said SQL databases;
a process for computer server-creating and generating SQL relations and compilations of said individual unique said words, terms, phrases and sentences each of said first unique words, terms, phrases and sentences related to individual SQL keys related to said words and terms representing individual diagnoses and/or group of diagnoses in and among SQL tables in said SQL databases;
a process for computer server-creating and generating SQL relations and compilations of individual second unique words and terms representing information and data on individual physicians and individual groups of physicians related to individual SQL keys each of said second unique words and terms related to said individual SQL keys related to said words and terms representing individual diagnoses and/or group of diagnoses in and among SQL tables in said SQL databases

6. The method according to claim 4 where in said process for computer server creating and generating individual unique SQL units in and among said SQL tables in said SQL databases from said relations and compilations of individual unique SQL keys related to individual words, terms, phrases, sentences, 2-dimensional and 3-dimensional representations of body parts, illustrations, figurines, graphics and related word and term headers or headings according to said innovative computer programs and software and stored procedures in said processor units and memories and computer server-automatically outputted to and related in and among said SQL tables in said SQL Server comprises:
a process for creating and generating relations and compilations of words, terms, phrases, sentences, 2-dimensional and 3-dimensional representations of body parts, illustrations, figurines, graphics and related word and term headers or headings representing and related to categories of diagnoses and/or syndromes, differential diagnoses and related chief complaints, signs and symptoms and PQRST, reviews of systems, physical examinations or findings, laboratory tests and results, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related qualifying information and data use by physicians of about 85 medical and surgical specialties and practices in computer files by physicians using said devices and platforms and submitting said relations and compilations to said processor units and memories from which said relations and compilations are computer server-automatically outputted and related by individual unique SQL keys and compiled, enabled by and according to said innovative computer programs and software and stored procedures, in and among said SQL tables in said SQL databases;
a process for computer sever-automatically creating, generating and compiling individual unique SQL units in said processor units and memories and computer automatically outputted said individual unique SQL units to said SQL tables in said SQL databases;
a process for computer sever-automatically creating, generating and compiling individual unique SQL units each of which is unique individual relations and compilations of individual unique SQL keys related to said individual words, terms, phrases or sentences representing individual diagnoses or individual syndromes and related individual SQL keys related to said individual words, terms, phrases and sentences representing individual chief complaints, signs and symptoms and PQRST, reviews of systems, physical examinations or findings, laboratory tests and results, anatomical locations, anatomical sites and organ systems, differential diagnoses, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related information and data on individual physicians or individual groups of physicians related to said individual unique SQL keys related to said individual words, terms, phrases or sentences representing individual diagnoses or individual syndromes, in and among said SQL tables in said SQL databases, generated in said processor units and memories and computer automatically outputted to said SQL tables in said SQL databases, enabled by and according to said innovative computer programs and software and stored procedures, enabled by and according to said innovative computer programs and software and stored procedures.

7. The process for computer sever-automatically creating, generating and compiling individual unique SQL units in said processor units and memories and computer automatically outputted said individual unique SQL units to said SQL tables in said SQL databases according to claim 6 includes:
a process for computer server-automatically and repetitively scanning and checking for duplicates or repeats, doubles related to individual diagnoses and individual syndromes and related said relational information and data in and among said SQL tables in said SQL databases in said processor units and memories;
a process for computer server-automatically and repetitively scanning and checking for duplicates or repeats, doubles related to diagnoses in individual groups of diagnoses or syndromes and related said relational information and data in and among said SQL tables in said SQL databases in said processor units and memories; and, consequently,
a process for computer server-automatically creating and generating individual unique SQL units comprising related unique individual SQL keys related to unique individual diagnoses and related unique individual SQL keys related to unique individual chief complaints, signs and symptoms and PQRST, reviews of systems, physical examinations or findings, laboratory tests and results, anatomical locations, anatomical sites and organ systems, macroscopic anatomy, microscopic anatomy, individual body sites, organ systems, DNA and RNA and biological and disease processes, differential diagnoses, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related information and data on individual physicians or individual groups of physicians in and among said SQL tables in said SQL databases; and
a process for computer server-automatically reassigning and relating individual SQL keys related to individual chief complaints, signs and symptoms and PQRST, reviews of systems, physical examinations or findings, laboratory tests and results, anatomical locations, anatomical sites and organ systems, macroscopic anatomy, microscopic anatomy, individual body sites, organ systems, DNA and RNA and biological and disease processes, differential diagnoses, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related information and data on individual physicians or individual groups of physicians in said relations and compilations of SQL keys to said unique individual SQL keys related to said unique individual diagnoses in said individual SQL units.

8. The method according to claim 4 wherein said process for computer server-automatically creating and generating relations individual unique SQL units in and among said SQL tables in said SQL databases comprises a process for computer server generating relations of individual unique SQL keys related to individual diagnoses in individual groups of diagnoses or syndromes in and among said SQL tables in said SQL databases in said processor units and memories.

9. The method according to claim 4 wherein said process for computer server-creating and generating individual electronic scan-and-search, signs-and-symptoms-body site plasmids henceforth individual SSPs comprises a process for computer server creating and generating individual unique signs and individual unique symptoms related to individual SQL keys related to individual keys related to individual words, terms and phrases representing macroscopic anatomy, microscopic anatomy, body sites, organ systems, biological and disease processes and events in and among SQL tables in said SQL databases.

10. The method according to claim 4 wherein said process for generating individual unique words, terms, phrases or sentences representing individual unique chief complaints, individual unique signs, individual unique symptoms and individual unique PQRST, individual unique reviews of systems, individual unique physical examinations or findings, individual unique laboratory tests and results, DNA and RNA and biological and disease processes and events related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes in processor units and memories and in and among said SQL tables in said SQL databases comprises:
a process for computer server-automatically and repetitively scanning and checking for duplicates or repeats, doubles related to said individual chief complaints, individual signs, individual symptoms and related individual PQRST, individual reviews of systems, individual physical examinations or findings, individual laboratory tests and results related to said individual unique keys related to said individual diagnoses or individual syndromes in all said SQL units, in and among said SQL tables in said SQL databases, in said processor units and memories; and, consequently,
a process for relating said individual chief complaints, individual signs, individual symptoms and related individual PQRST, individual reviews of systems, individual physical examinations or findings, individual laboratory tests and results to individual unique anatomical locations, macroscopic anatomy, microscopic anatomy, individual body sites, organ systems, DNA and RNA and biological and disease processes and events using said devices or platform and submitting said relations and compilations to said processor units and memories; and, consequently,
a process for computer server creating and generating individual unique words, terms, phrases or sentences representing individual unique chief complaints and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases;
a process for computer server creating and generating individual unique words, terms, phrases or sentences representing individual unique signs and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases;
a process for computer server creating and generating individual unique words, terms, phrases or sentences representing individual unique symptoms and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases;
a process for computer server creating and generating individual unique words, terms, phrases or sentences representing individual unique reviews of systems and individual unique PQRST and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases;
a process for computer server creating and generating individual unique words, terms, phrases or sentences representing individual unique physical examinations and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases; and
a process for computer server creating and generating individual unique words, terms, phrases or sentences representing individual unique laboratory testing and results and related individual SQL keys each of which are related to clinically relevant individual unique SQL keys related to individual unique anatomical locations, macroscopic anatomy, microscopic anatomy, individual body sites, organ systems, DNA and RNA and biological and disease processes and events in said SQL tables in said SQL databases.

11. The method according to claim 4 wherein said process for computer server creating and generating individual SQL relations and compilations comprising said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases comprises:
a process for generating individual relation and compilation of SQL keys related to individual unique words, terms, phrases or sentences representing individual unique chief complaints and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, chief complaint-body site plasmids or individual CCBPs—in processor units and memories and in said SQL tables in said SQL databases;
a process for generating individual relation and compilation of SQL keys related to individual unique words, terms, phrases or sentences representing individual unique signs and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, sign-body site plasmids or individual SNBPs—in processor units and memories and in said SQL tables in said SQL databases;
a process for generating individual relation and compilation of SQL keys related to individual unique words, terms, phrases or sentences representing individual unique symptoms and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, symptom-body site plasmids or individual SMBPs—in processor units and memories and in said SQL tables in said SQL databases;
a process for generating individual relation and compilation of SQL keys related to individual unique words, terms, phrases or sentences representing individual unique review of systems and related PQRST related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, symptom-body site plasmids or individual RSBPs—in processor units and memories and in said SQL tables in said SQL databases;
a process for generating individual relation and compilation of SQL keys related to individual unique words, terms, phrases or sentences representing individual unique physical examinations related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, physical examination-body site plasmids or individual PEBPs—in processor units and memories and in said SQL tables in said SQL databases; and
a process for generating individual relation and compilation of SQL keys related to individual unique words, terms, phrases or sentences representing individual unique laboratory tests and results related to individual unique SQL keys related to individual unique anatomical locations, macroscopic anatomy, microscopic anatomy, individual body sites, organ systems, DNA and RNA or biological and disease processes and events and individual unique keys related to individual diagnoses and individual syndromes—henceforth known individual electronic scan-and-search, laboratory test and result-body site plasmids or individual LBBPs—in processor units and memories and in said SQL tables in said SQL databases.

12. The method according to claim 4 wherein said process for generating said SQL relations and compilations of said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases in said viewing screens of said computers, laptops, hand-held and mobile devices and equipment in said network or networks by and among physicians and patients using computers, laptops, hand-held and mobile devices and equipment comprises:
a process for computer server-automatically generating, retrieving and displaying interactive said individual CCBPs, interactive said individual SNBPs, interactive said individual SMBPs, interactive said individual RSBPs, interactive said individual PEBPs, interactive said individual LBBPs and any combination thereof in a plurality of individual adaptable interactive linked electronic templates, pop-up and drop-down comprising said individual CCBPs, individual SNBPs, individual SMBPs, individual RSBPs, individual PEBPs and/or individual LBBPs body-site-related, body-site-associated with or clinically relevant to interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens of said computers, laptops, hand-held and mobile devices and equipment, upon pointing cursors with mice and/or fingers in said interactive words, terms, phrases, sentences, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in said viewing screens by and among physicians and patients using computers, laptops, hand-held and mobile devices and equipment;
a plurality of individual adaptable interactive linked electronic templates, pop-up and drop-down comprising said individual unique SQL units related to individual words, terms, phrases, sentences, 2-dimensional and 3-dimensional representations of body parts, illustrations, figurines, graphics and related word and term headers or headings accompanied by a search function in said viewing screens upon prompting by pointing of cursors, selecting, clicking and/or keyboarding in said viewing screens by and/or among said physicians and/or patients; and consequently,
a process for computer server-automatically generating, retrieving and displaying interactive said individual unique chief complaints and related PQRST associated with said interactive said individual CCBPs, interactive said individual unique signs and related PQRST associated with said interactive said individual SNBPs, interactive said individual unique symptoms and related interactive PQRST associated with said interactive said individual SMBPs, interactive said individual unique review of systems and related interactive PQRST associated with said interactive said individual RSBPs, interactive said individual unique physical examinations associated with said interactive said individual PEBPs, interactive said individual unique laboratory tests and results associated with said interactive individual LBBPs and any combination thereof in said plurality of individual adaptable interactive linked electronic templates, pop-up and drop-down comprising said individual CCBPs, individual SNBPs, individual SMBPs, individual RSBPs, individual PEBPs and/or individual LBBPs body-site-related, body-site-associated with or clinically relevant to interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens of said computers, laptops, hand-held and mobile devices and equipment by and among physicians and patients using computers, laptops, hand-held and mobile devices and equipment, upon pointing cursors with mice and/or fingers in said interactive words, terms, phrases, sentences, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in said viewing screens by and among physicians and patients using computers, laptops, hand-held and mobile devices and equipment, enabled by JavaScript, AJAX and HTML, Flash programs and said innovative computer programs and software, stored procedures, Web browsers and Web server; and
a plurality of individual adaptable interactive linked electronic templates, pop-up and drop-down comprising said relational information and data related to said outcomes of said scans and matches accompanied by a search function in said viewing screen.

13. The method according to claim 4 wherein said process for activating and using said computer server-assisting managements and controls of diseases, illnesses and disorders and related developments, courses, recurrences, progressions and preventions by and among physicians and patients using computers, laptops, hand-held and mobile devices and equipment in said network or networks comprises:
said process for generating said SQL relations and compilations of said individual unique SQL keys related to clinically relevant individual SQL keys related to interactive individual unique anatomical locations, macroscopic anatomy, microscopic anatomy, individual body sites, organ systems, DNA and RNA and biological and disease processes and events in said SQL tables in said SQL databases in said viewing screens of said computers, laptops, hand-held and mobile devices and equipment in said network or networks upon pointing cursors with mice and/or fingers in said interactive words, terms, phrases, sentences, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in said viewing screens by and among physicians and patients using computers, laptops, hand-held and mobile devices and equipment;
a process for pointing cursors with mice and/or fingers, selecting and clicking said interactive said individual unique chief complaints and related PQRST associated with said interactive said individual CCBPs, interactive said individual unique signs and related PQRST associated with said interactive said individual SNBPs, interactive said individual unique symptoms and related interactive PQRST associated with said interactive said individual SMBPs, interactive said individual unique review of systems and related interactive PQRST associated with said interactive said individual RSBPs, interactive said individual unique physical examinations associated with said interactive said individual PEBPs, interactive said individual unique laboratory tests and results associated with said interactive individual LBBPs and any combination thereof in said plurality of individual adaptable interactive linked electronic templates, pop-up and drop-down comprising said individual CCBPs, individual SNBPs, individual SMBPs, individual RSBPs, individual PEBPs and/or individual LBBPs body-site-related, body-site-associated with or clinically relevant to interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens of said computers, laptops, hand-held and mobile devices and equipment by and among physicians and patients using computers, laptops, hand-held and mobile devices and equipment, upon pointing cursors with mice and/or fingers in said interactive words, terms, phrases, sentences, 2-dimensional and 3-dimensional representations of body parts, illustrations, figurines, graphics, highlights, contrasts, macroscopic anatomy, microscopic anatomy, individual body sites, organ systems, DNA and RNA and/or biological and disease processes and events in said viewing screens by and among physicians and patients using computers, laptops, hand-held and mobile devices and equipment;
a process for computer server-automatically and continually adjusting, editing, setting and resetting said displays of said interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events consequent to said process for varying said pointing of cursors, selecting and clicking in said viewing screens by or by and among said physicians and/or patients; and, consequently
a process for computer server-automatically and sequentially scanning and matching said selected individual unique chief complaints and related PQRST, selected said individual unique signs and related PQRST, selected said individual unique symptoms and related interactive PQRST, selected said individual unique review of systems and related interactive PQRST selected said individual unique physical examinations adjustably and relevantly associated to any and all displayed interactive words, terms, phrases, sentences, 2-dimensional and 3-dimensional representations of body parts, illustrations, figurines, graphics, highlights, contrasts, representing the macroscopic anatomy, microscopic anatomy, individual body sites, organ systems, DNA and RNA and/or biological and disease processes and events in said viewing screens with said individual words, terms, phrases and sentences representing individual chief complaints, signs and symptoms and PQRST, reviews of systems, physical examinations or findings, laboratory tests and results related to said individual unique SQL keys related to individual unique SQL keys related to individual diagnoses or individual syndromes, in and among said SQL tables in said SQL databases, in said processor units and memories;
a process for computer server-sequentially and dynamically adapting, adjusting, responding and displaying said variable outcomes of said process for computer server-automatically and sequentially scanning and matching; and consequently,
a process for computer server-sequentially and dynamically selecting and displaying said plurality of diagnoses and/or, precisely, selecting and displaying individual diagnoses and related information and data on biological and disease processes and events and related information and data on individual physicians or individual groups of physicians in said viewing screens for or for and among said physicians and/or patients, enabled by said individual unique SQL keys in said individual unique SQL units in and among said SQL tables in said SQL databases according to said innovative computer programs and software and stored procedures, enabled by and according to said innovative computer programs and software and stored procedures.

14. In a computer server or servers for assisting the managements and controls of diseases, illnesses and disorders and related developments, courses, recurrences, progressions and preventions henceforth servers by and among physicians and patients using computers, laptops, hand-held and mobile devices and equipment for accessing said servers henceforth devices and teleconferencing platform networked to said servers and devices henceforth platform in a network or networks of said servers, devices and platform, a method for computer server-precisely retrieving individual diagnoses and related categories of information and data and related biological and disease processes and events and related information and data on individual physicians or individual groups of physicians by said servers by, for and/or among physicians and/or patients using said devices and platform for accessing said servers in said network or networks comprises:
a process for operating said operating and functioning computer servers including said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt, Flash and video enabled programs, and said innovative computer programs and software coupled to, communicating with and commanding said SQL Server, processor units and memories, adaptable interactive linked Web pages and electronic templates and numerous linked interactive pop-up and drop-down lists of words, terms, phrases, sentences, 2-dimensional and 3-dimensional representations of body parts, illustrations, figurines, graphics, highlights, contrasts, the macroscopic anatomy, microscopic anatomy, individual body sites, organ systems, DNA and RNA and biological and disease processes and events in said viewing screens, teleconferencing platforms comprising teleconferencing technologies and related devices and equipment, and said devices for accessing said servers by and among said individual physicians, individual groups of physicians, individual patients, individual physicians and patients comprising keyboards and viewing screens including touch-enabled viewing screens or touchscreens, enabled by Web browsers and said Web server in said network or networks;
a process for creating, implementing and applying SQL relations and compilations in said SQL tables in said SQL databases;
a process for creating, implementing and applying said innovative computer programs and software and stored procedures coupled to said processor units, memories and SQL Server in said servers;
a process for creating and generating relations and compilations of words, terms, phrases, sentences, 2-dimensional and 3-dimensional representations of body parts, illustrations, figurines, graphics and related word and term headers or headings representing and related to categories of diagnoses and/or syndromes, differential diagnoses and related chief complaints, signs and symptoms and PQRST, reviews of systems, physical examinations or findings, laboratory results, anatomical locations, anatomical sites and organ systems, diagnoses, syndromes, genetics, etiologies, causes, sources and pathologic basis of diseases and illnesses, family histories, travel histories, treatments, surgeries, procedures, assessments and plans, medications, recommendations, advices, referrals and follow-ups and related adjectives and variables and synonyms, acronyms and graphics and related qualifying information and data use by physicians of about 85 medical and surgical specialties and practices in computer files by physicians using said devices and platforms and submitting said relations and compilations to said processor units and memories from which said relations and compilations are computer server-automatically outputted and related by individual unique SQL keys and compiled, according to said innovative computer programs and software and stored procedures, in and among said SQL tables in said SQL databases;
a process for computer server creating and generating individual unique SQL units in and among said SQL tables in said SQL databases from said relations and compilations of individual unique SQL keys related to individual words, terms, phrases, sentences, 2-dimensional and 3-dimensional representations of body parts, illustrations, figurines, graphics and related word and term headers or headings according to said innovative computer programs and software and stored procedures in said processor units and memories and computer server-automatically outputted to and related in and among said SQL tables in said SQL Server;
a process for computer server-automatically creating and generating relations individual unique SQL units in and among said SQL tables in said SQL databases;
a process for computer server creating and generating individual unique words, terms, phrases or sentences representing individual unique chief complaints, individual unique signs, individual unique symptoms and individual unique PQRST, individual unique reviews of systems, individual unique physical examinations or findings, individual unique laboratory results related to individual SQL keys which are related to individual unique SQL keys related to individual unique anatomical locations, macroscopic anatomy, microscopic anatomy, individual body sites, organ systems, DNA and RNA and biological and disease processes and events and individual unique keys related to individual diagnoses and individual syndromes in said SQL tables in said SQL databases;
a process for computer server creating and generating SQL relations and compilations of said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases;
a process for generating said SQL relations and compilations of said individual unique SQL keys related to clinically relevant individual SQL keys related to individual unique anatomical locations, macroscopic anatomy, microscopic anatomy, individual body sites, organ systems, DNA and RNA and biological and disease processes and events in said SQL tables in said SQL databases in said viewing screens of said computers, laptops, hand-held and mobile devices and equipment in said network or networks by and among physicians and patients using computers, laptops, hand-held and mobile devices and equipment;
a process for activating and using said computer server-assisting managements and controls of diseases, illnesses and disorders and related developments, courses, recurrences, progressions and preventions by and among physicians and patients using computers, laptops, hand-held and mobile devices and equipment in said network or networks; and
a process for creating, generating, implementing and applying said SQL databases and the SQL relations and compilations in said SQL tables in said SQL databases in said servers in said network or networks by and according to said innovative computer programs and software and stored procedures in said processor units and memories and computer server-automatically outputted said relations and compilations to and related in and among said SQL tables in said SQL Server, enabled by and according to said innovative computer programs and software and stored procedures in said processor units and memories and computer server-automatically outputted to and related in and among said SQL tables in said SQL Server.
